(19) United States
(12) Patent Application Publication
(10) Pub. No.: US 2010/0325892 A1
(43) Pub. Date: Dec. 30, 2010

(54) RAZOR

(75) Inventor: Michael Axel Martin Nuber, Teningen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/918,846

(22) PCT Filed: Feb. 20, 2009
(86) PCT No.: PCT/IB2009/050701

§ 371 Date: Aug. 23, 2010

(30) Foreign Application Priority Data
Feb. 29, 2008 (EP) 08152109.8

(51) Int. Cl. B26B 19/00; B26B 19/28

(52) U.S. Cl. 30/34.1; 30/45

(57) ABSTRACT

The present invention provides a razor, comprising: a power source housing part, having power terminals and including a power source that is connected to the power terminals; and a first razor head housing part that is releasably connected to the power source housing part and having terminals that are connectable to the power terminals thereof, the first razor head housing part comprising a first cutting element and a first motor for driving the first cutting element; wherein the first razor head housing part defines a substantially water-tight unit. The razor head housing part can be replaced with a second razor head housing part that is connectable to the power source housing part and having terminals that are connectable to the power terminals thereof, the second razor head housing part comprising a second cutting element, which is different from the first cutting element, and a second motor for driving the second cutting element.

### FIELD OF THE INVENTION

The present invention relates to modular razors, comprising a motor for driving a replaceable hair cutting element, and a power source for providing (electrical) power to the motor.

### BACKGROUND OF THE INVENTION

US-2007/0050995-A1 provides a razor comprising a razor handle including a razor head, a grip tube and a battery shell. The razor head includes a connecting structure for mounting a replaceable razor cartridge on the razor handle. The razor cartridge includes a suitable cutting element. The grip tube includes a motor configured to cause vibration. The grip tube is a sealed unit, to which the razor head is attached, allowing modular manufacturing. The battery shell is removably attached to the grip tube, so that the user may remove the battery shell to replace the battery. The interface between the battery shell and grip tube is sealed, for instance, by an O-ring, providing a water-tight assembly. The modularity of the grip tube advantageously allows a single type of grip tube to be manufactured for use with various different razor head styles. This in turn simplifies manufacturing families of products with different heads but the same battery-powered functionality.

Although the razor of US-2007/0050995-A1 provides the advantages of the replaceable razor cartridge, the razor head and the razor cartridge turn out to be relatively noisy. Also, to be able to cut different types of hair, the speed and/or torque of the motor driving the cutting element included in the razor cartridge should ideally be adjusted. The speed of the motor of the razor of US-2007/0050995-A1 can be adjusted. However, in practice, the target user generally finds it difficult, if not impossible, to determine the most optimal settings. Many other prior art razors lack the possibility to adjust speed and torque of the cutting element, providing only a single setting for all types of hair.

### OBJECT OF THE INVENTION

The present invention aims to provide a razor that is quieter than existing modular razors.

### SUMMARY OF THE INVENTION

Therefore, the present invention provides a razor, comprising:
a power source housing part, having power terminals and including a power source that is connected to the power terminals; and
a first razor head housing part that is releasably connected to the power source housing part and having terminals that are connectable to the power terminals thereof, the first razor head housing part comprising a first cutting element and a first motor for driving the first cutting element;
wherein the first razor head housing part defines a substantially water-tight unit.

The modular razor of the invention provides cutting elements and a corresponding driving motor that are integrated in the same housing part. The housing part including the motor and cutting element is replaceable with another housing part, including another, different cutting element and a corresponding motor. Settings of speed and/or torque of the motor connected to each cutting element can be optimized for the respective cutting element. Control circuitry can be relatively simple and inexpensive, as user-controllable settings of speed and/or torque are obviated. Due to the integration of driving motor and the corresponding cutting element in one housing part, any mechanical couplings are also integrated in the same housing part. As the coupling can be optimized during fabrication, noise is significantly reduced relative to the above described prior art razor having an exterior mechanical coupling in between respective housing parts. The razor head housing parts can be fabricated using tighter tolerances than the housing parts of prior art modular razors, further decreasing noise. As all moving, noise creating parts are located in the same housing part, the noise can be isolated, making the razor of the invention unusually quiet and pleasant to use.

In an embodiment, the housing parts can include an isolation layer to further increase noise reduction.

Other, second, third, fourth and so forth, razor head housing parts including other, different, cutting elements and corresponding motors may be available. Each housing part includes an assembly of a motor and a respective cutting element that is optimized for different types of hair.

The power source housing part, the first razor head housing part and/or other razor head housing parts can be sealed water tight. This enables to clean the respective housing parts by rinsing.

According to other embodiments, the first razor head housing part, the second razor head housing part and/or the power source housing part are integral units, substantially lacking openings that allow a user to reach the interior of the unit. The integral units simplify cleaning thereof. Tolerances may be tighter and safety

### BRIEF DESCRIPTION OF THE DRAWINGS

FIG. 1A shows a sectional view of an embodiment of a razor according to the present invention;

FIG. 1B shows a sectional view of another embodiment of a razor according to the present invention;

FIG. 2 shows a sectional side view of an embodiment of a razor head housing part according to the invention; and

FIG. 3 shows a plan view of an embodiment of a razor of the present invention, including the razor head housing part of FIG. 3 and an exemplary comb.

### DETAILED DESCRIPTION OF EXAMPLES

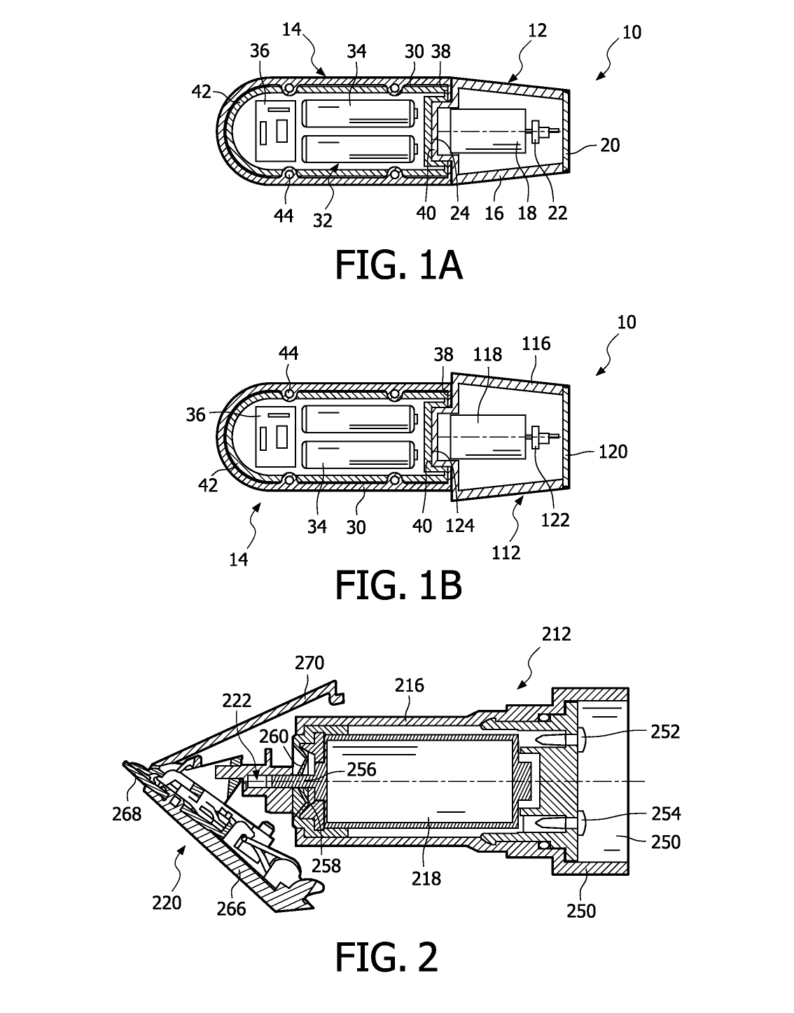

FIG. 1A shows a razor 10 of the present invention, including a first razor head housing part 12 and a power source housing part 14. The first razor head housing part comprises a casing 16 enclosing a motor 18. One side of the casing includes a cutting element 20 that is connected to the motor via mechanical coupling 22. To ensure that the razor head housing part is substantially water-tight, the casing 16 is provided with sealing elements to connect the coupling 22 to the cutting element. The sealing elements include for instance rubber O-rings or equivalent sealing means. On another side, the razor head housing part is provided with a protrusion 24. The protrusion is for instance provided with power terminals (not shown) for making electrical contact with the power source housing part 14.

The power source housing part 14 comprises a casing 30 including a power source 32. The power source 32 comprises for instance two batteries 34 that are enclosed within the casing 30. A driving circuit, for instance integrated circuit 36, is included in the casing for operating the razor. The driving circuit may include a processing unit, a memory and/or similar semiconductor devices. The driving circuit is connected to an on/off button (not shown) that is provided on the casing 30, for switching the razor 10 on or off. At one end 38, the casing 30 is adapted to receive the first housing part 12. The casing for instance includes a recess 40 for receiving the protrusion 24 of the first razor head housing part.

The inside of the casing 30 may be provided with layer 42, which is connected to the casing 30 by connectors 44. The layer 42 may be an isolation layer, isolating noises from inside the housing part 14. Likewise, the razor head housing part may include an isolation layer (not shown) inside the casing 16 for damping mechanical noise.

Near the recess 40, the casing 30 is provided with power terminals (not shown) that are connected to the power source 32. The power terminals contact the terminals of the casing 16 when the first and second housing parts are assembled, as shown in FIG. 1A.

The driving circuit 36 may optionally provide an indirect power supply, that separates the voltage of the battery 34 from the voltage actually provided at the power terminals. The voltage actually provided at the power terminals, and seen by the motor 18, is controlled by the control logic 36, which monitors the battery voltage and, in response to a measurement of battery voltage, controls circuitry that compensates for variations in battery voltage. This results in an essentially constant voltage provided at the power terminals.

FIG. 1B shows the razor 10 including the same power source housing part 14. The power source housing part is assembled with another, second razor head housing part 112. A connecting structure thereof includes protrusion 124, which connects to the power source housing part 14 like the protrusion 24. The second razor head housing part includes a casing 116 including a motor 118, a cutting element 120 and a coupling 122 connecting the motor to the cutting element.

The cutting element 120 (FIG. 1B) differs from the cutting element 20 (FIG. 1A). For instance, the cutting element 120 is optimized for another type of hair (thicker or thinner hair, longer or shorter hair, curly or straight hair, etc.). Otherwise, the cutting element 120 may be smaller or larger than cutting element 20 (for instance one for kids, and one for adults). The motor 120 may be the same motor as motor 20, or a different motor. However, settings of speed and/or torque may differ, depending on predetermined optimal settings for a certain cutting element. The mechanical couplings 22, 122 may provide a transmission to determine said settings.

Likewise, any number of additional razor head housing parts may be provided, each including a cutting element for a certain type of hair, a respective motor and a mechanical coupling arranged therein between. Each razor head housing part combines the most ideal motor with each respective cutting element in the same housing part. The motor is exchanged together with the cutting element, to ensure that always the most optimal combination of motor and cutting element is used. Mechanical tolerances can be tighter than the releasable coupling of the prior art razor. In fact, the lowest tolerances that are possible can be used to fabricate the razor head. Tolerances concern for instance the couplings 22, 122. Tighter tolerances decrease noise output and provide an unusually quiet razor head.

The razor head housing parts 12, 112 are sealed water tight. Thus, the housing parts can be cleaned easily, for instance by rinsing with water. Also, the lack of openings in the casing of the sealed housing parts further reduces the noise levels.

FIG. 2 shows razor head housing part 212, including casing 216, motor 218, cutting element 220 and mechanical coupling 222.

At one end, the razor head housing part comprises an extending cylindrical part 250 for receiving a power source housing part. The cylindrical part 250 includes electrically conducting terminals 252, 254 for receiving electrical power, and for providing the electrical power to the motor 218.

At the opposing end, the coupling 222 includes a driving shaft 256 that extends through opening 258 of the casing 216. The opening 258 is provided with sealing means 260 to ensure that the opening 258 is sealed substantially water-tight. The sealing means 260 for instance include a ring, flap, and/or bellow of a suitable, flexible material. The material comprises for instance rubber or a plastic having equivalent characteristics.

The cutting element for instance comprises a sliding surface 266 for sliding over a skin surface. At an end of the sliding surface, an array of cutting teeth 268 is arranged. The coupling 222 can transmit a vibrating movement to the cutting teeth, which can vibrate relative to the sliding surface. A protecting structure 270 is arranged to protect the cutting element and the coupling, and to prevent a user from contacting the coupling.

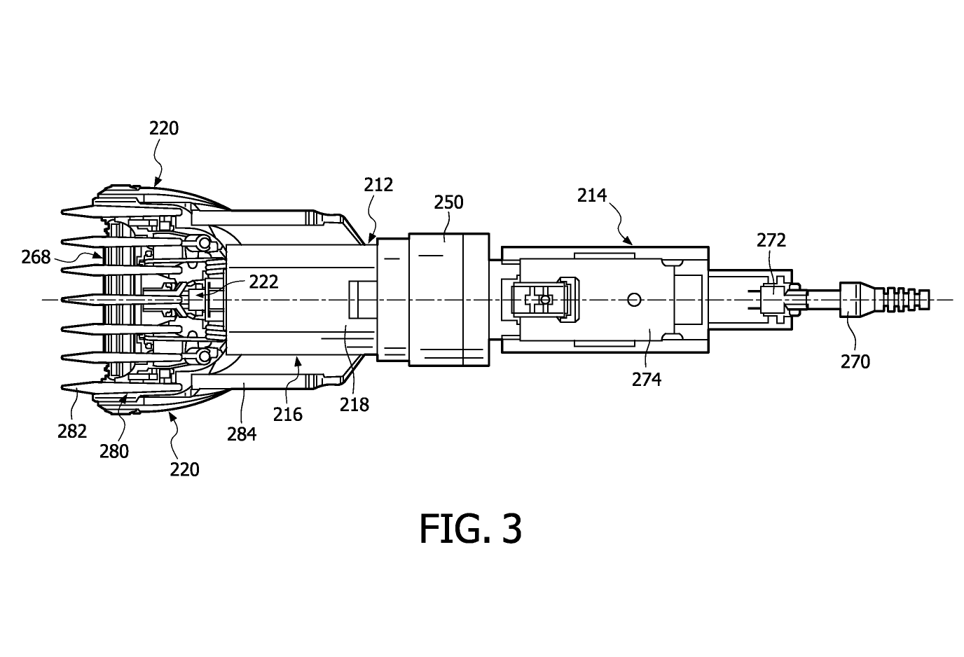

FIG. 3 shows a plan view, wherein the razor head housing part 212 is assembled with a power source housing part 214. An end of the power source housing part is arranged within the cylindrical part 250. Power terminals of the housing part 214 contact the terminals 252, 254.

The power source housing part is connected to power chord 270 via connector 272. The power chord 270 can be connected to mains, or an equivalent exterior power source. The power chord can optionally be disconnected from the housing part 214. The housing part 214 includes a power storage device 274. The power storage device may include any suitable means, such as a battery, and/or a capacitor.

A removable comb 280 covers the cutting element 220. The comb comprises teeth 282 and cylindrical sleeve 284. The sleeve extends around the casing 216. The teeth 282 maintain a predetermined distance between skin and the cutting teeth 268, to ensure that hairs are cut at a length that substantially corresponds to the predetermined distance.

The present invention is not limited to the above described embodiments thereof. Many modifications of the embodiments are conceivable within the scope of the appended claims. Also, features of embodiments can be combined.

1. Razor (10), comprising:
a power source housing part (14), having power terminals and including a power source (32) that is connected to the power terminals; and
a first razor head housing part (12) that is releasably connected to the power source housing part and having terminals that are connectable to the power terminals thereof, the first razor head housing part comprising a first cutting element (20) and a first motor (18) for driving the first cutting element;
wherein the first razor head housing part defines a substantially water-tight unit.

2. The razor of claim 1, further comprising at least a second razor head housing part (112) that is connectable to the power source housing part (14) and having terminals that are connectable to the power terminals thereof, the second razor head housing part comprising a second cutting element (120), which is different from the first cutting element, and a second motor (118) for driving the second cutting element,
wherein the second razor head housing part defines a second substantially water-tight unit.

3. The razor of claim 2, wherein fixed settings of speed and/or torque of the second motor (118) are different from fixed settings of the respective speed and torque of the first motor (18).

4. The razor of claim 3, wherein the settings of speed and/or torque of the first motor (18) are optimized for the first cutting element (20), and wherein the settings of speed and torque of the second motor (118) are optimized for the second cutting element (120).

5. The razor of claim 1, wherein the first razor head housing part (12) is an integral unit, substantially lacking openings that allow a user to reach the interior of the unit.

6. The razor of claim 1, wherein the first razor head housing part includes an isolation layer for damping noise, the isolation layer substantially covering the interior of a casing (16) of the first razor head housing part.

7. The razor of claim 1, wherein the power source housing part (14) is an integral unit, substantially lacking openings that allow a user to reach the interior of the unit.
